(19) United States
(12) Patent Application Publication
(10) Pub. No.: US 2002/0062255 A1
(43) Pub. Date: May 23, 2002

(54) METHOD OF SELLING CONTACT LENS

(76) Inventors: HIDENARI TANAKA, NAGOYA-SHI (JP); HIROSHI MURAKAMI, NAGOYA-SHI (JP); TATUHIKO HAYASHI, NAGOYA-SHI (JP); YOSHIHARU YAMADA, NAGOYA-SHI (JP); KAZUTOSHI TAKASE, KUMAMOTO-KEN (JP); TETSUKAZU NAKAMURA, NAGOYA-SHI (JP); AKIRA ISHIHARA, NAGOYA-SHI (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/209,454

(22) Filed: Dec. 11, 1998

(30) Foreign Application Priority Data
Dec. 12, 1997 (JP) 9-343306

(51) Int. Cl. G06F 17/60

(52) U.S. Cl. 705/26

(57) ABSTRACT

This invention provides a contact lens selling system which can retain the safety of the contact lens at all hours. The contact lens selling system is comprised of a communication network and plurality of information processing apparatuses connected through the communication network. Plurality of information processing apparatuses are comprised of at least one of a first information processing apparatus, a second information processing apparatus and a third information processing apparatus. The transmitting/receiving means of the first information processing apparatus is a means for transferring information on the registration number, specified department of ophthalmology, contact lens price and the money paying deadline to the second information processing apparatus, and is a means for transferring information on registration number and name to the third information processing apparatus. The transmitting/receiving means of the second information processing apparatus is a means for transferring information on the contract application to the first information processing apparatus. The transceiver means of the third information processing apparatus is a means for transferring information on registration number, name, selling date, contact lens information and eyeball diagnosis information to the first information processing apparatus.

### BACKGROUND OF THE INVENTION

The present invention relates to a system for selling contact lens by using plurality of information processing apparatus connected through a communication network. More particularly, the invention relates to a contact lens selling system capable of retaining the safety of the contact lens at all hours.

First, one example of the conventional contact lens selling method will be described.

The contact lens is to be selected by a doctor when a contact lens user buys the contact lens. It is necessary for the doctor to select the contact lenses in accordance with the contact lens users because the contact lens has various types and standards. The contact lens is divided in type into a hard contact lens and a soft contact lens. The hard contact lenses are further classified in terms of oxygen permeability, while the soft contact lenses are further classified depending on whether water content and element material are ionic or not. The contact lenses standards are classified in criterion, depending on radius of curvature of inner face, degree, diameter and so on. Information on the type and standard of the contact lens is referred to as “contact lens information”.

The selection of the contact lenses are normally conducted based on, for example, the radius of curvature of cornea, the diameter thereof, refraction degree, tear volume and cornea endothelial cells (hereinafter referred to as “eyeball diagnosis information”), using object, age and using environment obtained by diagnosing and examining the eyeball or refractive degree of the contact lens user.

The contact lens user pays the medical fee to a doctor who diagnosed to the eyeball. The user receives the contact lens at a contact lens selling store and pays the contact lens price and the contact lens care articles price there. The contact lens care articles remove the dirt attached to the contact lens. Especially, in the soft quality contact lens including water in the lens material, the contact lens care article sterilizes germs existing within the lens, whereby harms may not be given to the eyes by keeping the contact lens clean at all hours. The contact lens care articles need to maintain the good visibility. The contact lens store buys the contact lenses in advance from the contact lens selling agency.

Every time the contact lens care articles are consumed after the purchases of the contact lenses, the contact lens user purchases the contact lens care articles at the contact lens selling store or the store selling contact lens care articles stores.

In the conventional contact lens selling method, the contact lens store purchases contact lenses in advance from the contact lens selling agency as described above, thereby to sells a contact lens selected by a doctor to a contact lens user. Thus, the contact lens selling agency makes it impossible to grasp the using situation of the contact lens sold. The contact lens is often used continuously after the exchanging time thereof. Moreover, the contact lens user needs upon occasion to buy the contact lens care articles which become consumption articles. The user often buys and uses by mistake the improper contact lens care articles which do not agree with the characteristics of the contact lens material purchased. The contact lens cannot be kept clean, thus being harmful to the eyes or making the contact lens opaque, whereby good visibility cannot be retained.

Accordingly, an object of this invention is to provide a contact lens selling system capable of retaining the safety of the contact lenses at all hours by grasping the using situation of the contact lens sold.

### SUMMARY OF THE INVENTION

The contact lens selling system of this present invention is comprised of a communication network and plurality of information processing apparatuses connected through the communication network,

the plurality of information processing apparatuses having at least each of a calculation processing means, a storage means, and a transmitting/receiving means,

the plurality of information processing apparatuses comprising of at least a first information processing apparatus and a second information processing apparatus and a third information processing apparatus,

wherein the transmitting/receiving means of the first information processing apparatus is a means for transferring at least one information on registration number, specified department of ophthalmology, contact lens price, contact lens care articles price and deadline for price payment from the first information processing apparatus to the second information processing apparatus and a means for transferring at least one information on registration number, name, sex and pass-word from the first information processing apparatus to the third information processing apparatus,

wherein the transmitting/receiving means of the second information processing apparatus is a means for transferring at least one information on application for contract from the second information processing apparatus to the first information processing apparatus, and

wherein the transmitting/receiving means of the third information processing apparatus is a means for transferring information on at least one of registration number, name, selling date, contact lens information and eyeball diagnosis information from the third information processing means to the first information processing means.

The information processing apparatus further has a displaying means,

wherein the displaying means is one of a cathode ray tube and a liquid crystal displaying apparatus.

The information processing apparatus further has an inputting means,

wherein the inputting means is a key board, a scanner, a mouse, or a bar code reader.

The storing means is comprised of a read-only memory and a random access memory.

The transmitting/receiving means is a modem.

A contact lens selling system of this invention is comprised of a network, plurality of processing apparatuses connected through the communication network, and a portable recording medium,

wherein the plurality of information processing apparatuses have at least one of a means for writing data in the portable recording medium, a means for reading data from the portable recording medium, calculation processing means, storing means and transmitting/receiving means,

wherein the plurality of information processing apparatuses are divided into at least a first group and a second group for separate application,

wherein the first group comprises an information processing apparatus installed in a facility related to the contact lens seller,

wherein the second group comprising an information processing apparatus installed in a specified department of ophthalmology,

wherein the information processing apparatus includes the second group stores at least one data on name, diagnosis date, eyeball diagnosis information of the contact lens user, contact lens information and contact lens selling date, obtained on the diagnosis results of the contact lens user in the department of ophthalmology where the information processing apparatus to be included in the second group is installed, and transmits the date through the communication network to the information processing apparatus to be included in the first group,

wherein the information processing apparatus included in the first group processes and controls the data, deciding the registration number based on the data, records the data and the registration number in the portable recording medium, to decide the exchanging time of the contact lens based on the diagnosis date and the contact lens selling date, whereby the information on at least the contact lens exchanging time is fed to the contact lens user at the exchanging time of the contact lens.

Only the information processing apparatus included in the second group has a means of correcting the eyeball diagnosis information.

The portable recording medium can be used by the specific contact lens user.

The portable recording medium have one password respectively.

The plurality of information processing apparatuses can read data from all the portable recording medium and write the data in all the portable recording medium.

The information processing apparatus further has a displaying means,

wherein the displaying means is one of cathode ray tube and the liquid crystal displaying apparatus.

The information processing apparatus further has an input means,

wherein the inputting means is a key board, a scanner, a mouse, or a bar code reader.

The storing means is comprised of a read-only memory and a random access memory.

The transceiver means is a modem.

### BRIEF DESCRIPTION OF THE DRAWINGS

FIG. 1 is an explanatory view showing EMBODIMENT 1 of a system for selling contact lens of the present invention;

FIG. 2 is an explanatory view showing EMBODIMENTS 2 of a system for selling contact lens of the present invention:

FIG. 3 is an explanatory view showing an example of a first group information processing apparatus;

FIG. 4 is a block diagram showing a flow of contract in the case where the selling system of the present invention is applied to a closed-membership selling system;

FIG. 5 is a block diagram showing a flow of money and articles in the selling system of FIG. 4;

FIG. 6 is a block diagram showing an example of process after a term of contract expires in the case where the selling system of the present invention is applied to a closed-membership selling system; and

FIG. 7 is a block diagram showing an example of total of the system in the case where the selling system of EMBODIMENT 1 and EMBODIMENT 2 of the present invention are applied to a closed-membership selling system.

### DETAILED DESCRIPTION

The embodiments of contact lens selling system of the present invention will be explained hereinafter.

### Embodiment 1

The EMBODIMENT 1 of the contact lens selling system of the present invention will be explained with referring to drawings. In the drawings, a contact lens is abbreviated to “CL”.

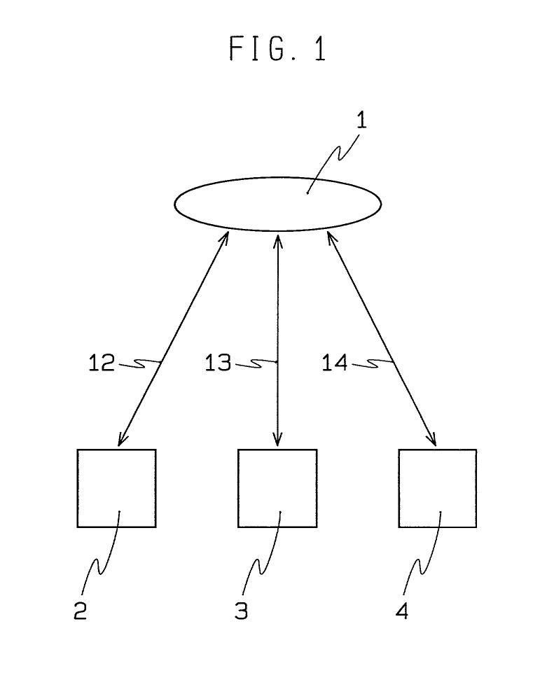

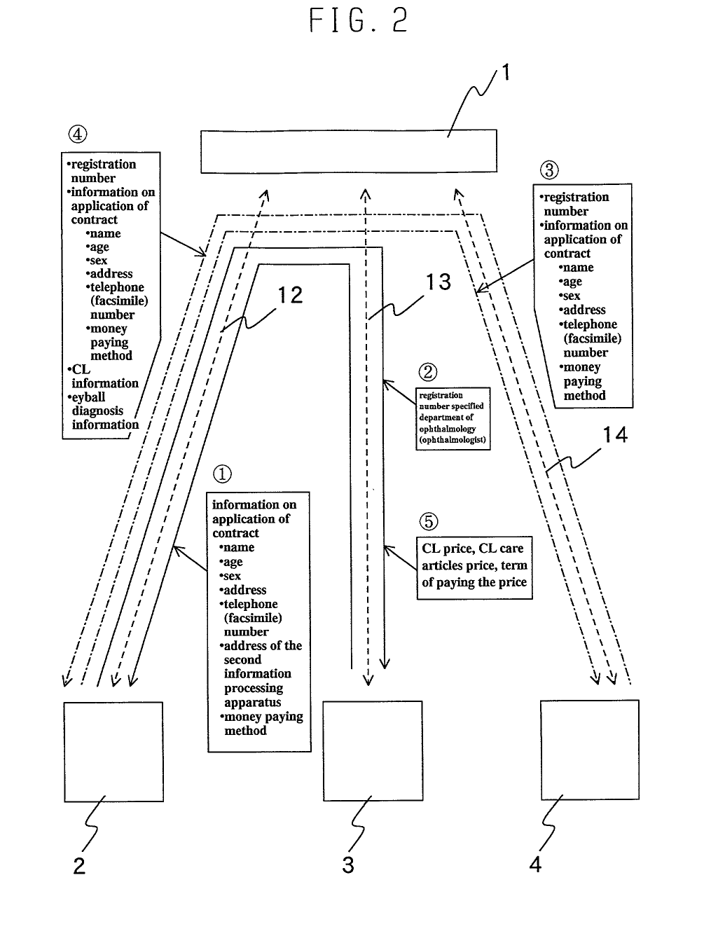

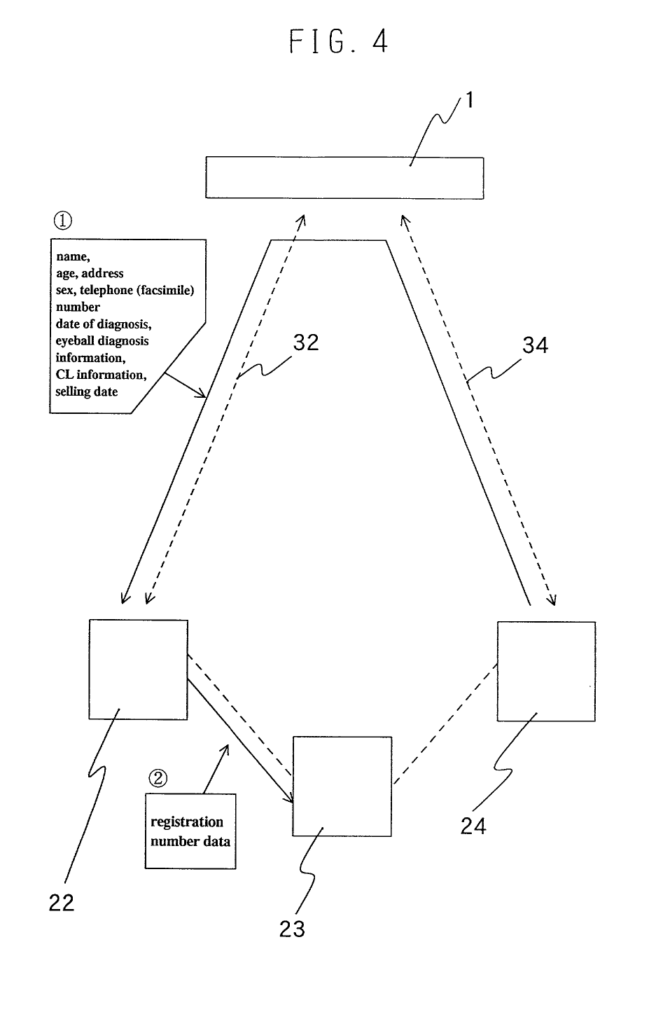

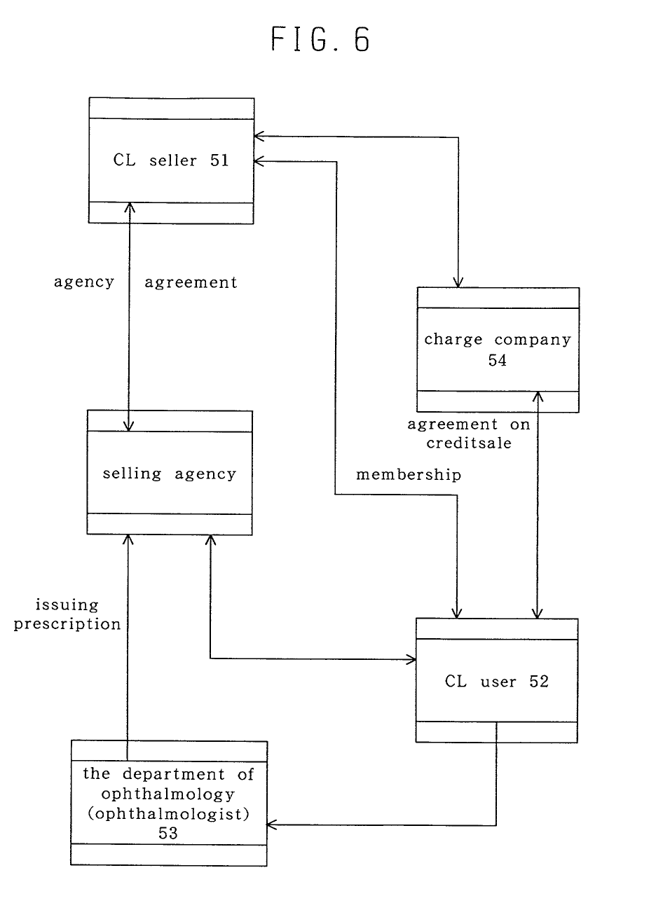

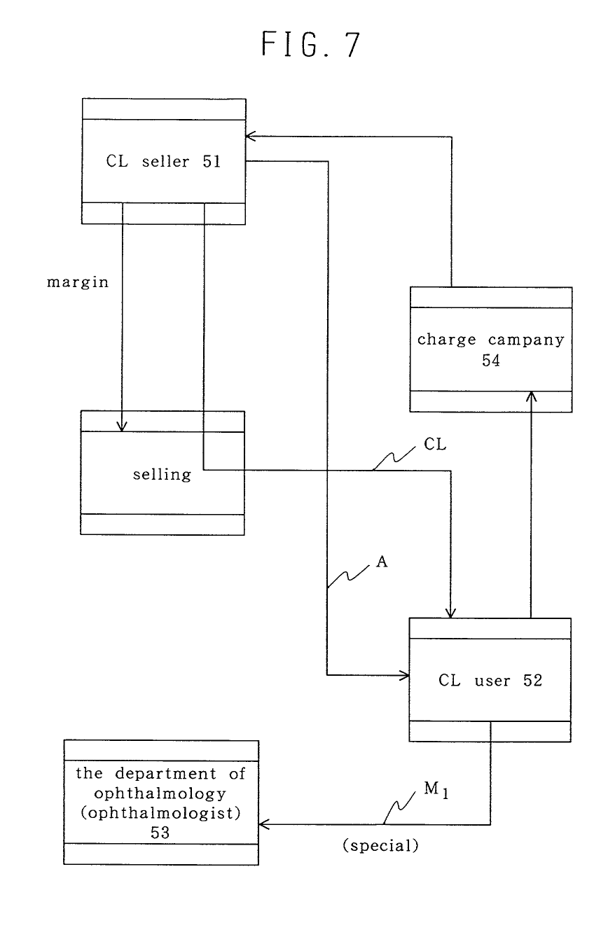

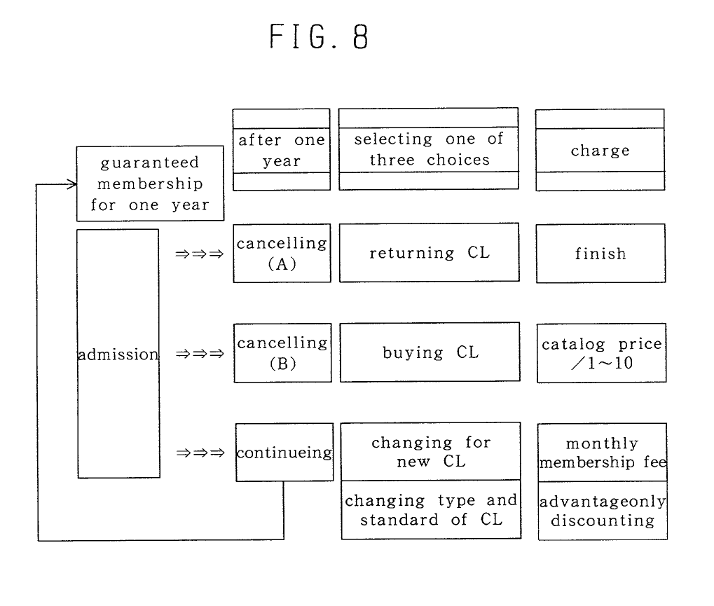

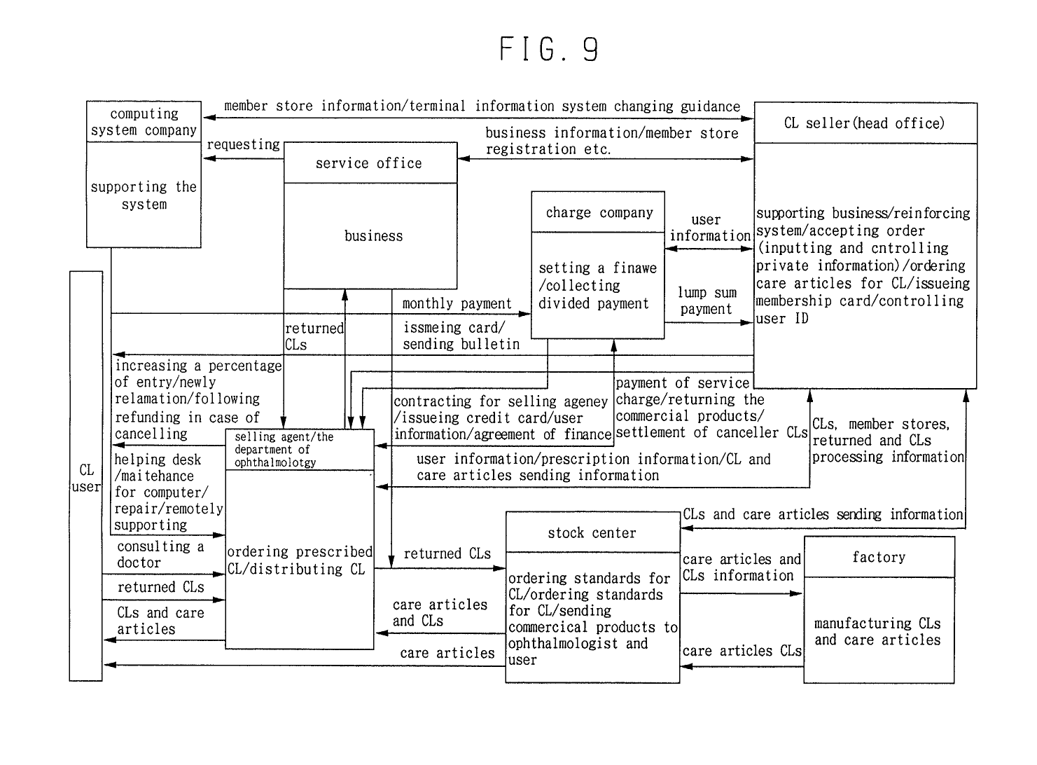

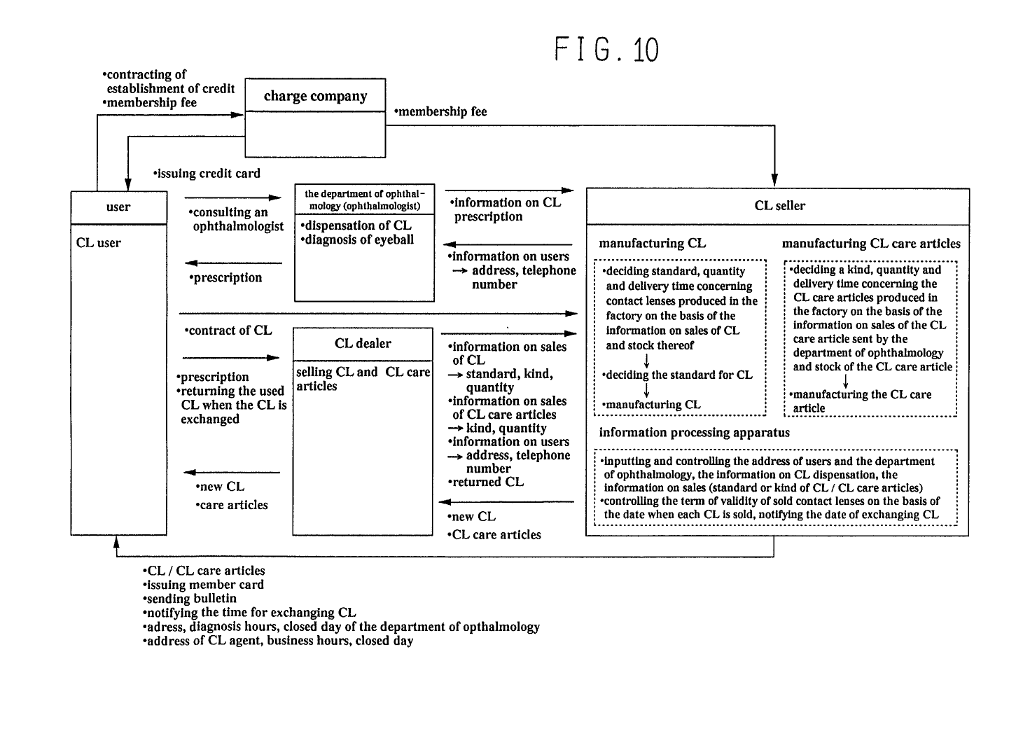

FIGS. 1 to 2 are an explanatory views showing the EMBODIMENT 1 of the contact lens selling system of this invention; FIG. 6 is a block diagram showing flow of contract in the case where the selling system of the present invention is applied to a closed-membership selling system. FIG. 7 is a block diagram showing a flow of money and articles in the selling system of FIG. 4.

Referring to FIGS. 1 to 2, reference numeral 1 is a communication network, reference numeral 2 is a first information processing apparatus, reference numeral 3 is a second information processing apparatus, and reference numeral 4 is a third information processing apparatus.

The conventional computer network is provided as one example of the communication network 1. A personal communication circuit is used for connection between the information processing apparatuses. The connection can be conducted by using personal communication circuit only between the first information processing apparatus 2 and the third information processing apparatus 4. The connection can be conducted through the conventional computer network between the first information processing apparatus 2 and the second information processing apparatus 3 and between the second information processing apparatus 3 and the third information processing apparatus 4.

The first information processing apparatus 2, the second information processing apparatus 3 and the third information processing apparatus 4 have a calculation processing means, a storing means and a transceiver means respectively. Each information processing apparatus sometimes has a displaying means and an inputting means. There is a cathode ray tube or a liquid crystal displaying apparatus as one example of the displaying means. There are a key board, a scanner, a mouse, a bar code reader as one example of the inputting means. There is a CPU as one example of the calculation processing means. There are a read-only memory and a random access memory as one example of the storing means. There is a modem as one example of the transceiver means.

The first information processing apparatus 2 is installed in a facility related to the contact lens selling agency. Some second information processing apparatus 3 are owned by the contact lens user, others are usable for the contact lens users. The third information processing apparatus 4 is installed in the specified department of ophthalmology (ophthalmologist). The specified department of ophthalmology (ophthalmologist) is registered in the first information processing apparatus 2 in advance. The contact lens is fed from the contact lens seller to the specified department of ophthalmology (ophthalmologist) upon registration.

Although the second information processing apparatus 3 or the third information processing apparatus 4 is shown in FIGS. 1 and 2, plurality of information processing apparatuses are actually connected the communication network 1 as the second information processing apparatus or the third information processing apparatus. Although the first information processing apparatus 2 is shown by one in FIGS. 1 and 2, the first information processing apparatus can be provided for each region or plurality of first information processing can be connected with one central information processing apparatus. In this case, information can be transferred through the first information processing apparatus between the second information processing apparatus or the third information processing apparatus and the central information processing apparatus.

The transmitting/receiving means of the first information processing apparatus 2 can transfer at least one information on registration number, specified department of ophthalmology, contact lens price, contact lens care articles price and the price payment deadline from the first information processing apparatus 2 to the second information processing apparatus 3 through the circuit shown with arrow marks 12 and 13. The transmitting/receiving means of the first information processing apparatus 2 is to transfer information on registration number and name from the first information process apparatus 2 to the third information processing apparatus 4 through the circuit shown with arrow marks 12 and 14. (referring FIG. 2).

The transmitting/receiving means of the second information processing apparatus transfers information on application for contract from the second information processing apparatus 3 to the first information processing apparatus 2 through the circuit shown with arrow marks 12 and 13.

The transmitting/receiving means of the third information processing apparatus 4 transfers the registration number, name, selling date, and contact lens information and the eyeball diagnosis information of the contact lens user from the third information processing apparatus 4 to the first information processing apparatus 2 though the circuit shown with arrow marks 12 and 14 (referring to FIG. 2).

A contact lens selling method using the EMBODIMENT 1 of the contact lens selling system of this invention will be described below.

Information on the application for the contract is transferred from the second information processing apparatus 3 to the first information processing apparatus 2. Information on the application of the contract includes the names, age, sex, address, telephone number (FAX number) of the contact lens user, the address of the second information processing apparatus 3 and the money paying method of the contact lens.

The registration number is assigned by the calculation processing means of the first information processing apparatus 2 so that the information on the application for the contract and the registration number are stored in the storing means of the first information processing apparatus 2. The registration number is attached to identify the contact lens user 52 within the selling system.

Then, the informations on the registration number, the residential area of the contact lens user 52 and the specified department of ophthalmology (ophthalmologist) 53 residing therearound are transferred from the first information processing apparatus 2 to the second information processing apparatus 3. When desired, information on all the department of ophthalmology (ophthalmologist) 53 are transferred. The information on the application for the contract and the registration number are transferred from the first information processing apparatus 2 to the third information processing apparatus 4. The information of the specified department of ophthalmology (ophthalmologist) 53 includes at least hospital number, address (map if necessary), telephone number (FAX number), holidays, consultation hours. Whenever the information is required by the contact lens user 52, informations on the specified department of ophthalmology (ophthalmologist) 53 are transferred anytime from the first information processing apparatus 2 or the third information processing apparatus 4 to the second information processing apparatus 3. The registration number is required to the transfer.

A contact lens user is diagnosed to obtain the eyeball diagnosis information. The contact lens is selected based on the eyeball diagnosis information, the using object, the age, the using environment and so on. The contact lens information of the selected contact lens and the eyeball diagnosis information are inputted to the third information processing apparatus 4. At this time, the contact lens user 52 can offer the registration number to the third information apparatus 4. The registration number can be affirmed by putting the name and the address of the contact lens user 52 to the third diagnosis information processing apparatus 4. The correction (writing) of the eyeball information can be conducted by using the third information processing apparatus 4 by ophthalmologist or a person which is allowed to input by him. The eyeball diagnosis information can be read by using the first information processing apparatus 2 or the third information processing apparatus 4 only by ophthalmologist, a person who is allowed to output by him, or a person which controls the eyeball diagnosis information among the contact lens selling agencies 51.

A contact lens user 52 receives contact lens of an appropriate type and standard and appropriate a care article A for the corresponding contact lens, at the same time, the user pays the specified department of ophthalmology (ophthalmologist) 53 for the charge Ml for diagnosis. Furthermore, the third information processing apparatus 4 is to transfer at least one of the registration number, name, sales date, contact lens information and the eyeball diagnosis information to the first information processing apparatus 2.

Finally the first information processing apparatus 2 is to transfer information on the contact lens price, the contact lens care article price and the deadline for the price payment to the second information processing apparatus 3. At this time, the contact lens user 52 can supply together with information on the account for money payment in paying money through the account transferring. Although the user can pay money through the charge company 54, it is generally necessary to take the steps necessary in this case.

The first information processing apparatus 2 can transmit the contact lens care articles A in accordance with the consumption period of the contact lens care articles by deciding the consumption period of the contact lens care articles in accordance with the selling date.

The first information processing apparatus 2 can decide the exchanging period by the selling date so that the contact lens may not be used continuously after the exchanging period is expired. If the exchanging deadline is approached, information showing that the exchanging period of the contact lens is getting closer can be transferred from the first information processing apparatus 2 to the second information processing apparatus 3 by means of electronic mail.

Not that the contact lens price and the care article price are paid at the contact lens purchasing time and after the purchasing, the contract price can be paid by the contact lens user 52 when the information on the contract application is transferred from the second information processing apparatus 3 and the prescribed money can be paid every month to the first information processing apparatus 2. When the prescribed money is paid every month, a new contact lens is provided preferably free of charge if the visibility changes, the contact lens is broken and considerable dirt and scratches are caused. When the exchanging time of the contact lens comes closer, the new contact lens is preferred to be provided free of charge.

### Embodiment 2

An EMBODIMENT 2 of the contact lens selling system of this invention will be described below with reference to the drawings. In the drawings, a contact lens is abbreviated to “CL”.

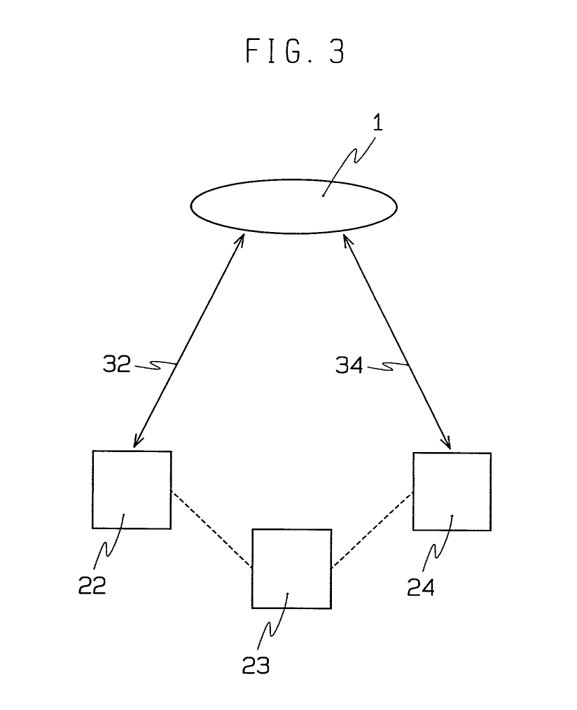

FIGS. 3 and 4 are each explanatory view showing the contact lens selling system of this invention. Referring now to FIGS. 3 and 4, reference numeral 1 is a communication network, reference numeral 22 is an information processing apparatus included in the first group, (hereinafter referred to as “first group information processing apparatus”), reference numeral 23 is a portable recording medium, reference numeral 24 is an information processing apparatus included in the second group (hereinafter referred to as “second group information processing apparatus”).

The first group is comprised of an information processing apparatus installed in a facility related to a contact lens seller. Although the first group information processing apparatus is shown by one in FIGS. 3 and 4, the information processing apparatus can be provided for each area or plurality of first information processing apparatuses can be connected with one central information processing apparatus. In this case, information can be transferred through the plurality of information processing apparatuses between the second group information processing apparatus and the central information processing apparatus. The second group is comprised of an information processing apparatus installed in the specified department of ophthalmology (ophthalmologist). Although the second group information processing apparatus is shown only by one in FIGS. 3 and 4, actually plurality of information processing apparatuses are connected with the communication network 1 as the second group information processing apparatus.

In the EMBODIMENT 2, the contact lens selling system comprises a communication network 1, a first group information processing apparatus 22, a second group information processing apparatus 24 and a recording medium 23. The first group information processing apparatus 22 is connected with the second group information processing apparatus 24 through the communication network 1.

As one example of the communication network 1 is the conventional computer network. The personal communication circuit can be used for connection between the first group information apparatus 22 and the second group information processing apparatus 24.

The first group information processing apparatus 22 is the same as the first information processing apparatus shown in the EMBODIMENT 1, except for a means for writing data on the recording medium 23, and a means for reading the data from the medium 23. Similarly the second group information processing apparatus 24 is the same as the third information processing apparatus shown in the EMBODIMENT 1, except for a means for writing the data on the recording medium 23 and a means for reading the data from the recording medium 23.

As an example of the recording medium 23 is an IC card, an ID card, magnetic tape, a floppy disc or paper. The recording medium 23 can be to confirm the person oneself with a photograph of the contact lens user 52 applied on it.

The second group information processing apparatus 24 serves to store the data on at least the name of the contact lens user 52, date of diagnosis, eyeball diagnosis information, the contact lens information and the contact lens selling date based on the diagnosis results of the contact lens user 52 in the department of ophthalmology (ophthalmologist) 53 where the second group information processing apparatus 24 is installed, and can transmit the data to the first group information processing apparatus 22 through the circuit shown with arrow marks 32 and 34 (referring to FIG. 4).

The first group information processing apparatus 22 processes and control the data, decides the registration number based on the data, records the data and the registration number on the recording medium 23, decides the exchanging time of the contact lens based on the date of diagnosis, the selling date of the contact lens and the kind of the contact lens, whereby the information notifying the exchanging time of the contact lens may be fed to the contact lens user 52 at the exchanging time of the contact lens. When the term of validity is close, preferably within one month before the term of validity, the contact lens user is informed of the term by mail or telephone (or FAX) in accordance with the address or phone (or FAX) number of the contact lens user which is controlled by the information processing apparatus. Alternatively, the contact lens user can be informed of the term of validity by electronic mail in accordance with the address by which the contact lens user wants to be informed. It is preferable that the means for informing the contact lens user of the term of validity are selected by the contact lens user when the contact lens users buy the contact lens.

In order to prevent the information of contact lens users 52 from being stored in one recording medium, a recording medium usable only by the specified contact lens user 52 is usable as the recording medium 23. Thus, contact lens users 52 cannot use one recording medium. For example, the respective one pass word the recording medium has can prevent plurality of contact lens users from using one recording medium. The pass word is not changeable unless the change application by the contact lens user 52 exists in the contact lens selling agency.

The information processing apparatus included in the selling system can read the data from all the recording medium, and write the data on all the recording medium. Thus, the user 52 can consult at a different specified department of ophthalmology every time. For example, even if the user 52 usually consults at the specified department of ophthalmology (ophthalmologist) near one's house, when the contact lens is broken, the new contact lens can be received immediately near the specified department of ophthalmology (ophthalmologist). The department of ophthalmology (ophthalmologist) diagnosis information can be corrected (written) by using the second group information processing apparatus 24 only by a ophthalmologist or a person which is entrusted with inputting by him. Further, the department of ophthalmology (ophthalmologist) diagnosis information can be read by using the first group information processing apparatus 22 or the second group information processing apparatus 24 only by an ophthalmologist, a person entrusted with outputting by him or a person who is approved to execute the department of ophthalmology (ophthalmologist) diagnosis information among the contact lens selling agency.

A contact lens selling method using the EMBODIMENT 2 of the contact lens selling system of this invention will be described below referring to FIGS. 6 and 7.

A contact lens user 52 applies to the contact lens seller 51 for contract. Upon the contract application, information of the contact lens user's 53 name, address, telephone number (FAX number), the money payment method of the contact lens, password and so on are fed to the contact lens seller 51. At the same time, information on the application for the contract inputted to the first group information processing apparatus 22. The registration number is assigned by the calculation processing means of the first group information processing apparatus 22. Information on the application of the contract and the registration number are stored to the storing means of the first group information processing apparatus 22, and the information on the application for the contract and the registration number are stored in the recording medium 23. The information on the specified department of ophthalmology (ophthalmologist) includes at least hospital number, address (map if necessary), telephone number (FAX number), the holidays, consultation hours. Anytime when the contact lens user 52 desires, the information on the specified department of ophthalmology (ophthalmologist) 53 is fed from the first information processing apparatus or the third information processing apparatus to the contact lens user 52. It is necessary to have the registration number and/or the password for the transferring.

The contract application can be conducted by the second group information processing apparatus 24. In this case, the information on the contract application is transferred from the second group information processing apparatus 24 to the first group information processing apparatus 22 through a circuit shown with arrow marks 32 and 34, and by return, the registration number is transferred from the first group information processing apparatus 22 to the second group information processing apparatus 24. The recording medium 23 is fed to the contact lens user later.

The information on the recording medium 23, and at least the department of ophthalmology (ophthalmologist) 53 in the contact lens user's 52 living area and around the area can be offered to the contact lens user 52 from the contact lens seller 51. Further, information on all the specified department of ophthalmology (ophthalmologist) can be submitted when desired. The information on the contract application and the registration number can be transferred through a circuit shown with arrow marks 32 and 34 from the first group information processing apparatus 22 to the second group information processing apparatus 24.

The contact lens user 52 is to obtain the eyeball diagnosis information by the consultation at the department of ophthalmology (ophthalmologist) 53. The contact lens is selected based on the eyeball diagnosis information, the using object, age and the using environment and so on. The selected contact lens information and the eyeball diagnosis information are inputted into the second group information processing apparatus 24 and at the same time, are stored in the recording medium 23.

The contact lens user 52 receives the contact lens of the appropriate type and standard, and contact lens care articles A appropriate to the contact lens, and pays the consultation fee M1 to the specified department of ophthalmology (ophthalmologist) 53. The second group information processing apparatus 24 transfers the registration number, name, selling date, contact lens information and the eyeball diagnosis information through the circuit shown with arrow marks 32 and 34 to the first group information processing apparatus 22.

Lastly, the first group information processing apparatus 22 supplies the information on the contact lens price, the contact lens care articles price and the money payment deadline to the contact lens user. At this time, the contact lens user 52 can supply together with information on the account for money payment in paying money through the account transferring. The user 52 can pay money through the charge company 54. In this case, it is generally necessary to take the prescribed steps.

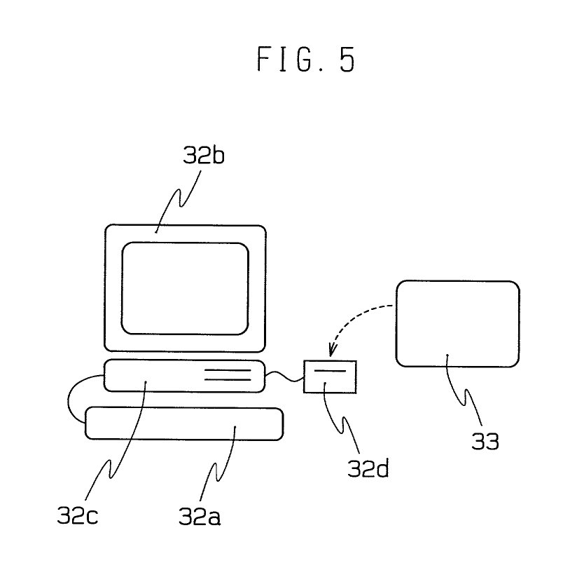

FIG. 5 is an explanatory view showing one example of the first group information processing apparatus to be included in the contact lens selling system of FIGS. 3 to 4. Referring to FIG. 5, reference numeral 32a is a key board as an input means, reference numeral 32b is a CRT (cathode ray tube) which is the displaying means, reference numeral 32c is a terminal machine main body including a calculation processing means, a storing means and a transmitting/receiving means, reference numeral 32d is an apparatus for reading and writing the storing medium including a means for reading the data from the portable recording medium and a means for writing the data on the portable recording medium, and reference numeral 33 shows an IC card which is a recording medium. For easier understanding, the IC card is enlarged as compared with the other illustrated drawings. The second group information processing apparatus of FIGS. 3 to 4 is also the same as the first group information processing apparatus shown in FIG. 5.

The first group information processing apparatus 22 can decide the consumption period of the contact lens care articles based on the selling date, and can transmit the contact lens care articles in accordance with the consumption period of the contact lens care articles.

The first group information processing apparatus 22 can decide the exchanging time of the contact lens based on the date of diagnosis, the selling date of the contact lens and the kind of the contact lens, whereby the information notifying the exchanging time of the contact lens may be fed to the contact lens user 52 at the exchanging time of the contact lens. When the term of validity is close, preferably within one month before the term of validity, the contact lens user is informed of the term by mail or telephone (or FAX) in accordance with the address or phone (or FAX) number of the contact lens user which is controlled by the information processing apparatus. Alternatively, the contact lens user can be informed of the term of validity by electronic mail in accordance with the address by which the contact lens user wants to be informed. It is preferable that the means for informing the contact lens user of the term of validity are selected by the contact lens user when the contact lens users buy the contact lens.

Not that the contact lens price and the contact lens care article price are paid at the contact lens purchasing time and after the purchasing thereof, the contract price can be paid by the contact lens user 52 when the contract application is conducted, and the specified money can be paid every month. When the specified money is paid every month, a new contact lens is provided preferably free of charge if the visibility changes, the contact lens is broken and considerable dirt and scratches are caused. When the exchanging time of the contact lens comes closer, the new contact lens is preferred to be provided free of charge.

According to the above-mentioned EMBODIMENTS 1 and 2, the information on the type and standard of the contact lens fed is given to the contact lens selling agency every time the contact lens is fed to the contact lens user. Thus, the stock amount of the contact lenses at each department of ophthalmology can be statistically processed for each type and standard of the contact lens, whereby the contact lens of type and standard required can be produced without excess and deficiency.

### Embodiment 3

The outline of the total system in which the selling system of EMBODIMENT 1 or EMBODIMENT 2 of the present invention is applied to the closed-membership selling system is shown in FIGS. 9 and 10. In the drawings, a contact lens is abbreviated to “CL”. In the EMBODIMENT 3, the term of the contract is one year. Therefore, any member is required to select any one of first choice to cancel the contract and return the contact lens to the contact lens seller, second choice to cancel the contract and take over the contact lens, or third choice to continue the contract (referring FIG. 8) after one year.

According to this invention, the safety of the contact lens can be retained by grasping the using situation of the contact lens after the selling.

What we claim is:

1. A contact lens selling system comprising a communication network and plurality of information processing apparatuses connected through the communication network,
the plurality of information processing apparatuses each having a calculation processing means, a storage means, and a transmitting/receiving means,
the plurality of information processing apparatuses comprising at least one of a first information processing apparatus and a second information processing apparatus and a third information processing apparatus,
wherein the transmitting/receiving means of the first information processing apparatus is a means for transferring at least one information on registration number, specified department of ophthalmology, contact lens price, contact lens care articles price and deadline for price payment from the first information processing apparatus to the second information processing apparatus and a means for transferring at least one information on registration number, name, age, sex and password from the first information processing apparatus to the third information processing apparatus,
wherein the transmitting/receiving means of the second information processing apparatus is a means for transferring at least one information on application for contract from the second information processing apparatus to the first information processing apparatus and
wherein the transmitting/receiving means of the third information processing apparatus is a means for transferring at least one information on at least registration number, name, age, sex, selling date, contact lens information and eyeball diagnosis information from the third information processing apparatus to the first information processing apparatus.

2. The contact lens selling system of claim 1, wherein the information processing apparatus further has a displaying means, wherein the displaying means is one of a cathode ray tube and a liquid crystal displaying apparatus.

3. The contact lens selling system of claim 1, wherein the information processing apparatus further has an inputting means, wherein the inputting means is a key board, a scanner, a mouse or a bar code reader.

4. The contact lens selling system of claim 1, wherein the storing means is comprised of a read-only memory and a random access memory.

5. The contact lens selling of claim 1, wherein the transmitting/receiving means is a modem.

6. A contact lens selling system comprising a network, plurality of processing apparatuses connected through the communication network, and a portable recording medium,
the plurality of information processing apparatuses having at least one of the means for writing data in the portable recording medium, the means for reading data from the portable recording medium, the calculation processing means, the storing means and transmitting/receiving means,
the plurality of information processing apparatuses being divided into at least a first group and a second group for separate application,
the first group comprising an information processing apparatus installed in a facility related to the contact lens seller,
the second group comprising an information processing apparatus installed in a specified department of ophthalmology,
the information processing apparatus including the second group stores at least one data on name, age, sex, date of diagnosis, eyeball diagnosis information of the contact lens user, contact lens information and contact lens selling date, obtained on the diagnosis results of the contact lens user in the department of ophthalmology where the information processing apparatus included in the first group is installed, and transmits the date through the communication network to the information processing apparatus included in the first group,
the information processing apparatus included in the first group processing and/or controlling the data, deciding the registration number based on the data, recording at least one of the data and the registration number in the portable recording medium, deciding the exchanging time of the contact lens based on the date of diagnosis and the contact lens selling date the kind of the contact lens, whereby the information on at least the contact lens exchanging time is fed to the contact lens user at the exchanging time of the contact lens.

7. The contact lens selling system of claim 6, wherein only the information processing apparatus included in the second group has a means of correcting the eyeball diagnosis information.

8. The contact lens selling system of claim 6, wherein the portable recording medium can be used by the specific contact lens user.

9. The contact lens selling system of claim 6, wherein the portable recording medium have one password respectively.

10. The contact lens selling system of claim 6, wherein the plurality of information processing apparatuses can read data from all of the portable recording medium and write the data in all of the portable recording medium.

11. The contact lens selling system of claim 6, wherein the information processing apparatus further has a displaying means, wherein the displaying means is one of cathode ray tube and the liquid crystal displaying apparatus.

12. The contact lens selling system of claim 6, wherein the information processing apparatus further has an input means, wherein the inputting means is a key board, a scanner, a mouse or a bar code reader.

13. The contact lens selling system of claim 6, wherein the storing means is comprised of a read-only memory and a random access memory.

14. The contact lens selling system of claim 6, wherein the transmitting/receiving means is a modem.
